(19) United States
(12) Patent Application Publication
(10) Pub. No.: US 2024/0314484 A1
(43) Pub. Date: Sep. 19, 2024

(54) Hearable with On-Head Detection using a Single Optical Sensor

(71) Applicant: Google LLC, Mountain View, CA (US)

(72) Inventors: Melissa Mira Zucker, San Francisco, CA (US); Yi Zhang, San Diego, CA (US); Yao Xue, San Jose, CA (US); Mi Zhou, San Jose, CA (US)

(73) Assignee: Google LLC, Mountain View, CA (US)

(21) Appl. No.: 18/184,460

(22) Filed: Mar. 15, 2023

(51) Int. Cl. H04R 1/10; G01V 8/12; G10K 11/178

(52) U.S. Cl. CPC H04R 1/1041; G01V 8/12; G10K 11/17825; G10K 11/17875; H04R 1/1016; H04R 1/1075; H04R 1/1083; G10K 2210/1081; G10K 2210/3011; G10K 2210/3026; H04R 2420/07; H04R 2460/01

(57) ABSTRACT

Techniques and apparatuses are described that implement a hearable with on-head detection using a single optical sensor. The hearable determines on-head detection based on a distance measured by the single optical sensor being less than a distance limit associated with on-head detection. A shape of the hearable's housing causes the hearable to have at least one orientation while at static equilibrium on a flat surface. This orientation causes the flat surface to be within the field-of-view of the optical sensor and causes a distance between the flat surface and the optical sensor to be greater than the distance limit associated with on-head detection. In this way, false positives associated with on-head detection can be mitigated without adding additional sensors (e.g., another infrared sensor, another proximity sensor, or a motion sensor) and without utilizing more complex optical sensors that determine additional information about the object, such as material composition.

### BACKGROUND

Wireless technology has become prevalent in everyday life, making communication and data readily accessible to users. One type of wireless technology are wireless hearables, examples of which include wireless carbuds and wireless headphones. Wireless hearables have allowed users freedom of movement while listening to audio content. To improve aesthetics and reduce encumbrance, it is desirable to design wireless hearables with smaller sizes. As space becomes limited, however, it can be challenging to integrate additional components within the wireless hearables.

### SUMMARY

Techniques and apparatuses are described that implement a hearable with on-head detection using a single optical sensor. The optical sensor, which can be an infrared sensor, measures a distance to an object within its field-of-view. The hearable determines on-head detection based on the measured distance being less than a distance limit associated with on-head detection. A physical shape of a housing of the hearable causes the hearable to have at least one orientation while at static equilibrium on a surface that is substantially flat. The at least one orientation causes the surface to be within the field-of-view of the optical sensor and causes a distance between the surface and the optical sensor to be greater than the distance limit associated with on-head detection. In this way, false positives associated with on-head detection can be mitigated without adding additional sensors (e.g., another infrared sensor, another proximity sensor, or a motion sensor) and without utilizing more complex optical sensors that determine additional information about the object, such as material composition.

Aspects described below include a wireless earbud configured to perform in-car detection. The wireless earbud includes a single optical sensor and a housing. The single optical sensor is configured to have a field-of-view and measure a distance to an object within the field-of-view for the in-ear detection. The housing is configured to have a shape that causes the wireless carbud to be at static equilibrium with at least one orientation on a surface that is substantially flat. The housing is also configured to form a cavity. The single optical sensor is positioned within the cavity such that, while the wireless earbud is at the static equilibrium on the surface, the surface is within the field-of-view of the single optical sensor based on the at least one orientation and a distance between the single optical sensor and the surface is greater than approximately eight millimeters based on the at least one orientation.

Aspects described below include a method for manufacturing a wireless earbud. The method includes providing a single optical sensor having a field-of-view and configured to measure a distance to an object within the field-of-view for in-ear detection. The method also includes providing a housing that forms a cavity and has a shape that causes the wireless earbud to be at static equilibrium with at least one orientation on a surface that is substantially flat. The method additionally includes positioning the single optical sensor within the cavity such that, while the wireless earbud is at static equilibrium on the surface, the surface is within the field-of-view of the single optical sensor based on the at least one orientation and a distance between the single optical sensor and the surface is greater than eight millimeters based on the at least one orientation.

Aspects described below also include a system with means for providing on-head detection using a single optical sensor.

### BRIEF DESCRIPTION OF DRAWINGS

Apparatuses for and techniques that implement a hearable with on-head detection using a single optical sensor are described with reference to the following drawings. The same numbers are used throughout the drawings to reference like features and components:

FIG. 1 illustrates an example environment in which a hearable with on-head detection using a single optical sensor can be implemented;

FIG. 2 illustrates an example implementation of a smart device;

FIG. 3 illustrates an example implementation of a hearable;

FIG. 4 illustrates an example lens structure of a hearable;

FIG. 5 illustrates an example geometry of a lens structure of a hearable to mitigate crosstalk for on-head detection;

FIG. 6 illustrates example orientations of a hearable at static equilibrium on a flat surface;

FIG. 7 illustrates an example flow diagram for performing on-head detection using a single optical sensor;

FIG. 8 illustrates an example method for manufacturing a hearable with on-head detection using a single optical sensor; and

FIG. 9 illustrates an example computing system embodying, or in which techniques may be implemented that enable use of, a hearable with on-head detection using a single optical sensor.

### DETAILED DESCRIPTION

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos. To improve aesthetics and reduce encumbrance, it is desirable to design wireless hearables with smaller sizes. As space becomes limited, however, it can be challenging to integrate additional components within the wireless hearables. Some wireless hearable designs can forego these additional components to meet a target size at the expense of lacking features that provide additional convenience to the user, such as on-head detection.

The term “on-head” detection (or automatic head detection) generally describes an ability of a wireless hearable to determine whether or not it is positioned on a head of the user. On-head detection can also be referred to as “in-ear” detection, particularly with respect to earbuds that are inserted into a user's ear canals. In general, on-head detection determines whether or not the wireless hearable is proximate to an car of the user. Based on the results of the on-head detection, the wireless hearables can control the rendering of audio content. For instance, the wireless hearable can initiate the rendering of audio content based on a determination that on-head detection is “true.” Alternatively, the wireless hearable can halt the rendering of audio content based on a determination that on-head detection is “false.” This feature enables the wireless hearable to conserve battery power and improve the user experience.

To provide on-head detection, some wireless hearable designs utilize infrared technology. With infrared technology, the wireless hearable can directly measure a distance between the wireless hearable and the user. It can be challenging, however, for some infrared sensors to determine whether the object it detects corresponds to the user or another nearby object. In some situations, the wireless hearable can incorrectly determine on-head detection is true while positioned on a substantially flat surface, such as a desk or table.

To avoid this false detection, some designs rely on information from other sensors, such as another proximity sensor (e.g., a capacitive sensor, an ultrasonic sensor, or a radar sensor) or a motion sensor (e.g., an accelerometer or an inertial measurement unit). These other sensors, however, can increase a size of the wireless hearable. Other designs can utilize multiple infrared sensors with different orientations. If both infrared sensors detect the object, on-head detection is determined to be “true.” Otherwise, on-head detection is determined to be “false.” Although these designs may be able to mitigate false detections, it can be challenging to fit additional sensors within the size constraints of the wireless hearable.

To address this issue, some designs utilize an infrared sensor with dual wavelengths to distinguish between different types of surface materials. With this ability, the infrared sensor can determine whether the object comprises human skin or another type of material. This type of infrared sensor, however, can be more expensive and complex relative to other infrared sensors that utilize single wavelengths and do not identify surface material composition.

To address these challenges, techniques for implementing a hearable with on-head detection using a single optical sensor are described herein. The optical sensor, which can be an infrared sensor, measures a distance to an object within its field-of-view. The hearable determines on-head detection based on the measured distance being less than a distance limit associated with on-head detection. A physical shape of a housing of the hearable causes the hearable to have at least one orientation while at static equilibrium on a surface that is substantially flat. The at least one orientation causes the surface to be within the field-of-view of the optical sensor and causes a distance between the surface and the optical sensor to be greater than the distance limit associated with on-head detection. In this way, false positives associated with on-head detection can be mitigated without adding additional sensors (e.g., another infrared sensor, another proximity sensor, or a motion sensor) and without utilizing more complex optical sensors that determine additional information about the object, such as material composition.

### Operating Environment

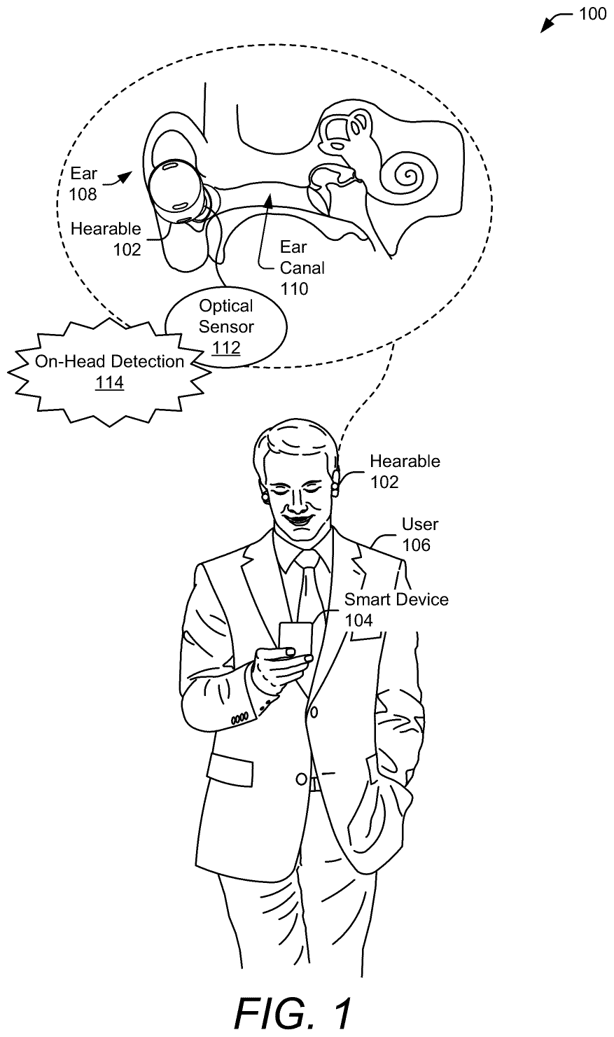

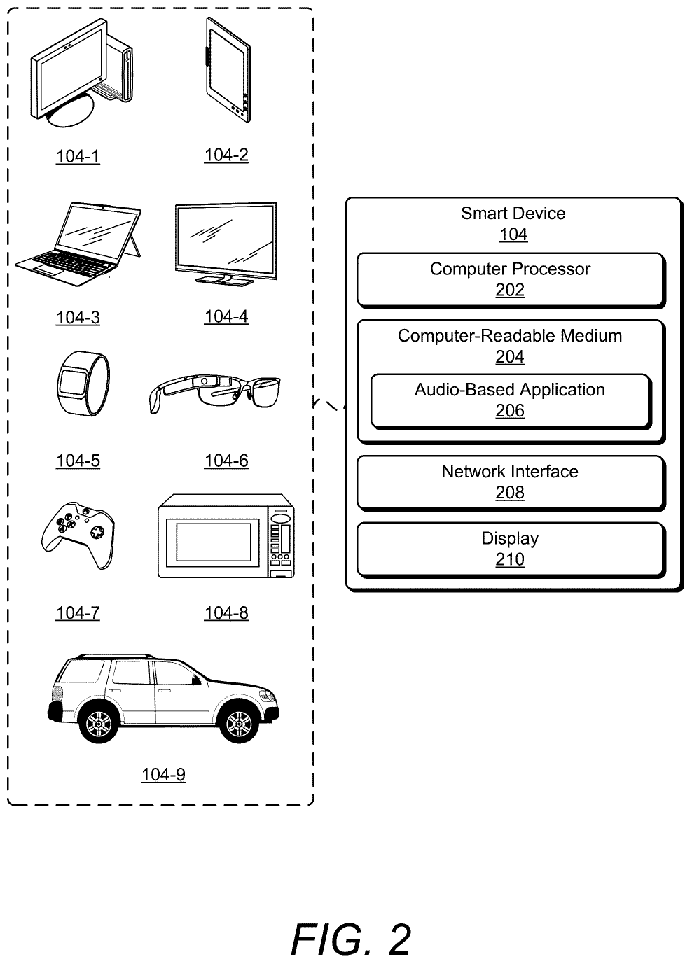

FIG. 1 is an illustration of an example environment 100 in which a hearable with on-head detection using a single optical sensor can be implemented. In the example environment 100, a hearable 102 is connected to a smart device 104 using a wireless interface. In other implementations, the hearable 102 can connect to the smart device 104 using a wired interface. The hearable 102 is a device that can play audible content provided by the smart device 104 and direct the audible content into a user 106′s ear 108. In some cases, the hearable 102 can provide stereo-quality sound. In this example, the hearable 102 operates together with the smart device 104. In other examples, the hearable 102 can operate or be implemented as a stand-alone device. Although depicted as a smartphone, the smart device 104 can include other types of devices, including those described with respect to FIG. 2.

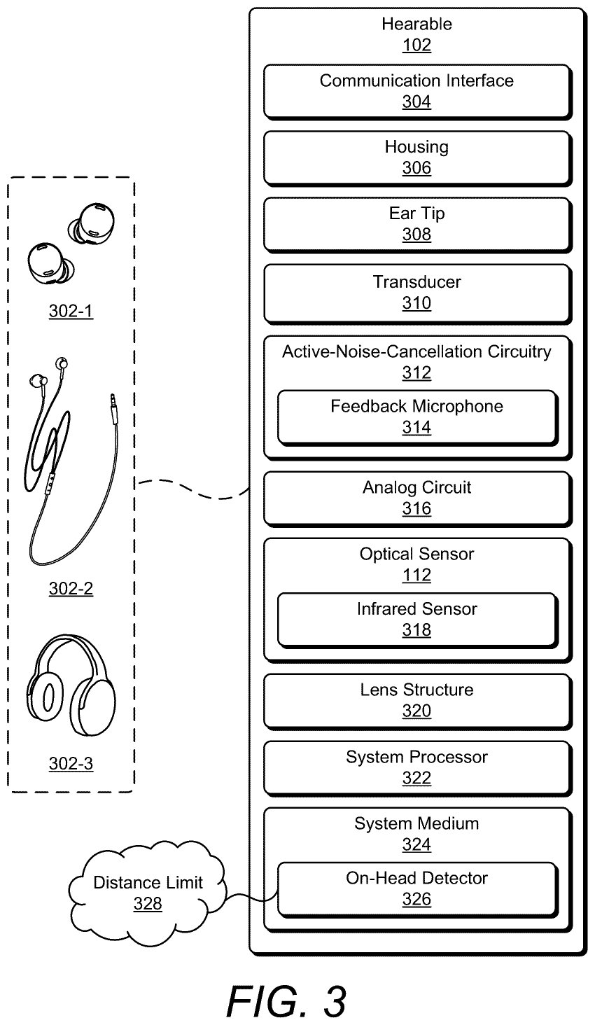

In this example, the hearable 102 represents an carbud (e.g., an carpiece, in-car headphones, or canalphones), which the user 106 inserts at least partially into their car canal 110. Although described with respect to carbuds, the techniques of implementing a hearable with on-head detection 114 using a single optical sensor can also be applied to other types of hearables 102, as further described with respect to FIG. 3, or other types of electronic devices, as further described with respect to FIG. 11.

The hearable 102 includes at least one optical sensor 112. In some implementations, the hearable 102 includes a single optical sensor 112. The techniques described herein enable the hearable 102 to perform on-head detection 114 using one optical sensor 112, which can be one of multiple optical sensors 112. With on-head detection 114, the hearable 102 can automatically detect when the user 106 places the hearable 102 proximate to their ear 108. As such, the hearable 102 can automatically determine when to play or pause audible content for the user 106.

Other hearables can be susceptible to false detection when at rest on a flat surface. A false detection occurs when the hearable 102 incorrectly determines that on-head detection 114 is true and the hearable 102 is not proximate to the head of the user 106. A position of the optical sensor 112 within the hearable 102 and an overall design of the hearable 102 enables the hearable 102 to perform on-head detection 114 using one optical sensor 112 while avoiding false detections. As such, the hearable 102 can perform on-head detection 114 based on a measured distance to the object (e.g., the user 106′s ear 108 or the flat surface) without referencing information from sensors other than the optical sensor 112 or relying on additional information, such as material composition, to mitigate false detections. In this manner, the hearable 102 can have a smaller size and be less expensive than other hearables 102 that mitigate false detections using additional sensors or a more complex sensor. The smart device 104 is further described with respect to FIG. 2.

FIG. 2 illustrates an example smart device 104. The smart device 104 is illustrated with various non-limiting example devices including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as a home service device, a smart speaker, a smart thermostat, a baby monitor, a Wi-Fi™ router, a drone, a trackpad, a drawing pad, a netbook, an e-reader, a home automation and control system, a wall display, and another home appliance. Note that the smart device 104 can be wearable, non-wearable but mobile, or relatively immobile (e.g., desktops and appliances).

The smart device 104 includes one or more computer processors 202 and at least one computer-readable medium 204, which includes memory media and storage media. Applications and/or an operating system (not shown) embodied as computer-readable instructions on the computer-readable medium 204 can be executed by the computer processor 202 to provide some of the functionalities described herein. The computer-readable medium 204 also includes an audio-based application 206, which passes audio content to the hearable 102 or accepts audio content from the hearable 102. For example, the audio-based application 206 can be a music or video application that provides audio content to the hearable 102. Additionally or alternatively, the audio-based application 206 can be a phone application or voice recorder that receives audio content from the hearable 102.

The smart device 104 can also include a network interface 208 for communicating data over wired, wireless, or optical networks. For example, the network interface 208 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The smart device 104 may also include a display 210. In some implementations, the hearable 102 can be integrated within the smart device 104, or can connect physically or wirelessly to the smart device 104. The hearable 102 is further described with respect to FIG. 3.

FIG. 3 illustrates an example hearable 102. The hearable 102 is illustrated with various non-limiting example devices, including wireless earbuds 302-1, wired carbuds 302-2, and headphones 302-3, which can be wireless or wired. An carbud 302-1 or 302-2 is a type of in-car device that fit, at least partially, into the car canal 110. Each earbud 302-1 or 302-2 can represent a hearable 102. Headphones 302-3 can rest on top of or over the ears 108. The headphones 302-3 can represent closed-back headphones, open-back headphones, on-ear headphones, or over-ear headphones. Each headphone 302-3 includes two hearables 102, which are physically packaged together. In general, there is one hearable 102 for each car 108.

The hearable 102 includes a communication interface 304 to communicate with the smart device 104, though this need not be used when the hearable 102 is integrated within the smart device 104. The communication interface 304 can be a wired interface or a wireless interface, in which audio content is passed from the smart device 104 to the hearable 102 or vice versa. The hearable 102 can also use the communication interface 304 to pass information regarding on-head detection 114 to the smart device 104. In general, the data provided by the communication interface 304 is in a format usable by the audio-based application 206. The communication interface 304 also enables the hearable 102 to communicate with another hearable 102 (e.g., another one of the carbuds 302-1 or 302-2 or another hearable that is part of the headphones 302-3.

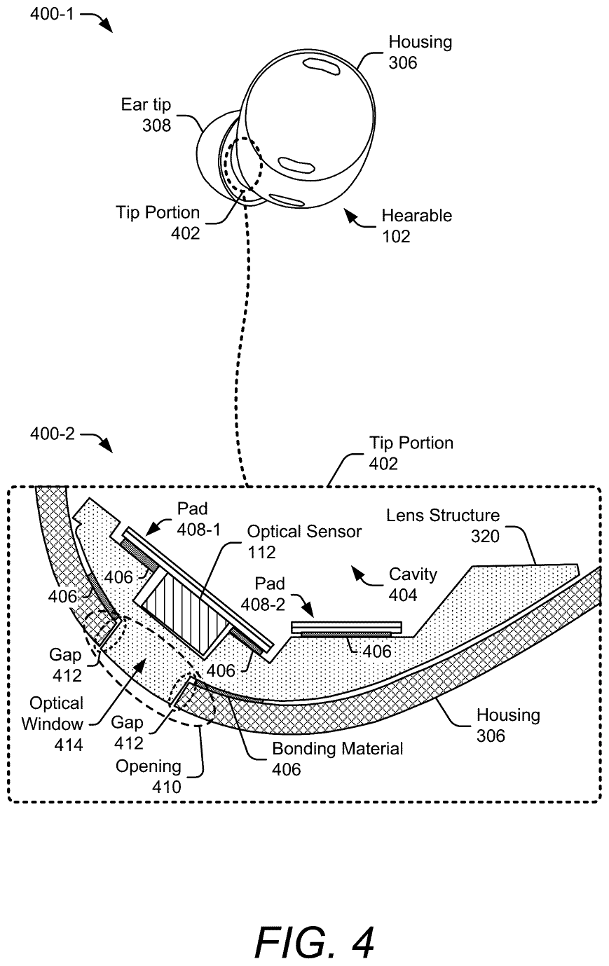

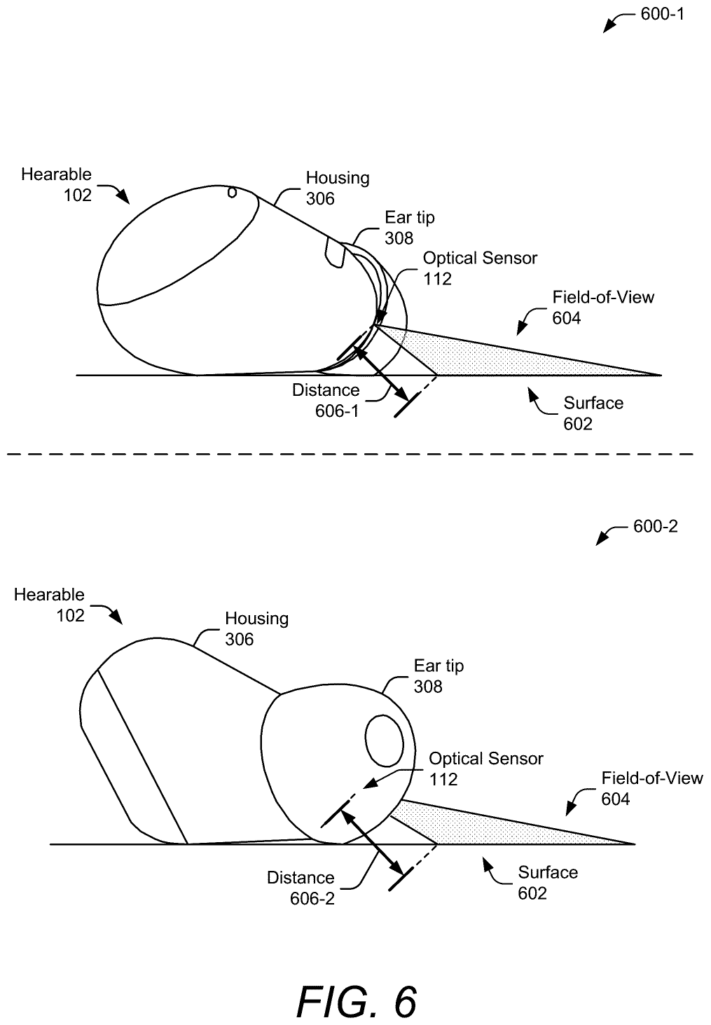

The hearable 102 includes a housing 306 (or exterior housing), which represents an external structure of the hearable 102. A shape (or geometry) of the housing 306 causes the hearable 102 to be at static equilibrium with at least one orientation on a surface that is substantially flat. Example orientations are further described with respect to FIG. 6. The housing 306 forms a cavity within which other components of the hearable 102 are positioned. The housing 306 can have at least one opening, as further described with respect to FIG. 4.

The hearable 102 can optionally include an car tip 308, which can be selectively attached to (e.g., selectively coupled to and decoupled from) a portion of the housing 306. With respect to the carbuds 302-1 or 302-2, the car tip 308 can represent a portion that is inserted at least partially into the car canal 110. Considering the headphones 302-3, the car tip 308 can represent a cushion that is placed on or over the car 108. In some implementations, the car tip 308 is made of a flexible material. In general, the car tip 308 abuts or is positioned against a portion in, on, or around the car 108.

The hearable 102 includes at least one transducer 310 that can convert electrical signals into sound waves and/or convert sound waves into electrical signals. These sound waves may include audible frequencies between 20 hertz (Hz) and 20 kilohertz (kHz). In some implementations, the transducer 310 can also transmit and/or receive signals at ultrasonic frequencies, which can include frequencies between 20 kHz and 2 megahertz (MHZ). The transducer 310 can be implemented as a speaker and/or a microphone.

In an example implementation, the transducer 310 has a monostatic topology. With this topology, the transducer 310 can convert the electrical signals into sound waves and convert sound waves into electrical signals (e.g., can transmit and receive acoustic signals). Example monostatic transducers may include piezoelectric transducers and capacitive transducers, and micro-machined ultrasonic transducers (MUTs) that use microelectromechanical systems (MEMS) technology.

Alternatively, the transducer 310 can be implemented with a bistatic topology, which includes multiple transducers that are physically separate. In this case, a first transducer converts an electrical signal into sound waves (e.g., transmits acoustic signals), and a second transducer converts sound waves into an electrical signal (e.g., receives the acoustic signals). An example bistatic topology can be implemented using at least one speaker and at least one microphone. The speaker and the microphone can be used for any of a variety of functions on behalf of the smart device 104 (e.g., presenting audible content to the user 106 or capturing the user's voice for a phone call or voice control).

In some implementations, the hearable 102 includes at least one speaker and at least on microphone. The speaker can be directed towards the car canal (e.g., oriented towards the car canal), and the microphone can be directed in an outward direction (e.g., away from the car). Accordingly, the speaker can direct acoustic signals towards the car canal, and the microphone can receive sound waves from an ambient environment (e.g., speech from a user).

The hearable 102 can optionally include active-noise-cancellation circuity 312, which enables the hearable 102 to reduce background or environmental noise. The active-noise-cancellation circuitry includes at least one feedback microphone 314.

The hearable 102 includes at least one analog circuit 316, which includes circuitry and logic for conditioning electrical signals in an analog domain. The analog circuit 316 can include analog-to-digital converters, digital-to-analog converters, amplifiers, filters, mixers, and switches for generating and modifying electrical signals. In some implementations, the analog circuit 316 includes other hardware circuitry associated with the transducer 310 and/or the active-noise-cancellation circuitry 312.

The hearable 102 also includes at least one optical sensor 112. The optical sensor 112 can measure a distance to an object by emitting light and detecting a portion of the light that is reflected by the object. In some implementations, the optical sensor 112 uses time-of-flight techniques or triangulation to measure the distance to the object. In an example implementation, the optical sensor 112 is implemented as an infrared sensor 318, such as an active infrared sensor. In some cases, the infrared sensor 318 performs aspects of on-head detection 114 by transmitting an infrared signal with a single wavelength to determine a distance to the object. Other implementations of the optical sensor 112 are also possible, including a laser sensor, a light detection and ranging (Lidar) sensor, a light-emitting diode (LED) time-of-flight (TOF) sensor, a time-of-flight camera, and so forth.

In some implementations, the optical sensor 112 can be implemented with a less complex or less costly sensor that does not support the transmission and reception of signals with complex waveforms, such as a signal with dual wavelengths. Additionally or alternatively, the optical sensor 112 may be unable to determine a material composition of the object. In other implementations, the optical sensor 112 can transmit complex waveforms, including signals with dual wavelengths, and optionally determine material composition of the object. The techniques for implementing the hearable 102 with on-head detection 114 using a single optical sensor 112. however, can be performed while operating the optical sensor 112 to transmit a signal with a simpler waveform having a single wavelength and without referencing the material composition of the object.

The hearable 102 additionally includes a lens structure 320, which can be composed of a type of plastic that is substantially transparent to light emitted and detected by the optical sensor 112. In the case of the infrared sensor 318, at least a portion of the lens structure 320 is substantially transparent to infrared signals. The term “substantially transparent” means that the lens structure 302 does not significantly attenuate the light (e.g., the infrared signals) that pass through it. In some cases, the lens structure 320 is substantially opaque to visible light (e.g., light visible to the human eye, or light with a wavelength ranging anywhere between approximately 400 and 700 nanometers) for aesthetic appeal. The lens structure 320 can at least partially fill an opening within the housing 306, as further described with respect to FIG. 4.

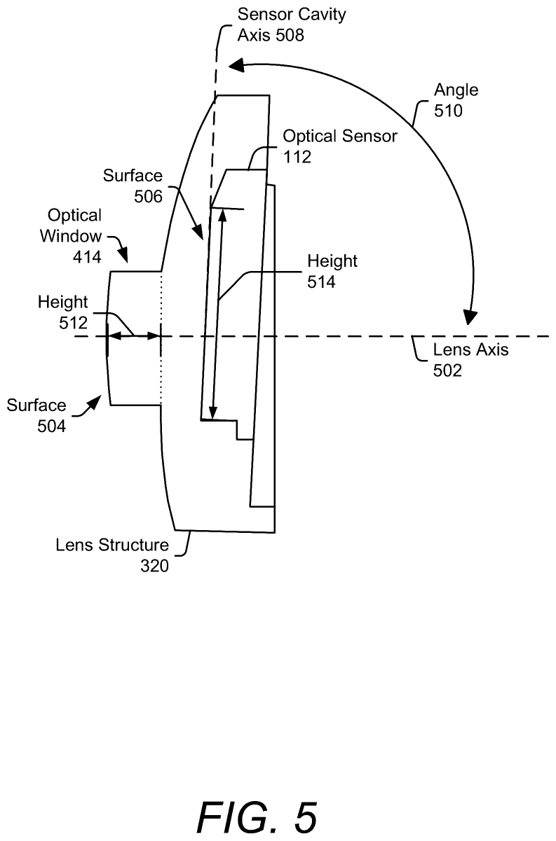

The lens structure 320 can extend across a portion of the cavity formed by the housing 306 and can function as a platform for positioning various components within the hearable 102. In other words, the lens structure 320 can function as a mounting structure. In example implementations, the optical sensor 112 is physically coupled to (e.g., attached to or mounted to) the lens structure 320, as shown in FIG. 4. A geometry of the lens structure 320 can be designed to minimize crosstalk produced by the optical sensor 112, as further described with respect to FIG. 5.

Other components can also be attached to the lens structure 320. For example, the feedback microphone 314 of the active-noise-cancellation circuitry 312 can be physically coupled to the lens structure 320. This can enable the feedback microphone 314 to be placed proximate to a portion of the hearable 102 that is positioned near the car canal 110. This positioning enables the feedback microphone 314 to monitor frequencies for active noise cancellation.

The hearable 102 also includes at least one system processor 322 and at least one system medium 324 (e.g., one or more computer-readable storage media). In the depicted configuration, the system medium 324 includes an on-head detector 326. The on-head detector 326 can be implemented using hardware, software, firmware, or a combination thereof. In this example, the system processor 322 implements the on-head detector 326. In an alternative example, the computer processor 202 of the smart device 104 can implement at least a portion of the on-head detector 326. In this case, the hearable 102 can communicate data generated by the optical sensor 112 to the smart device 104 using the communication interface 304.

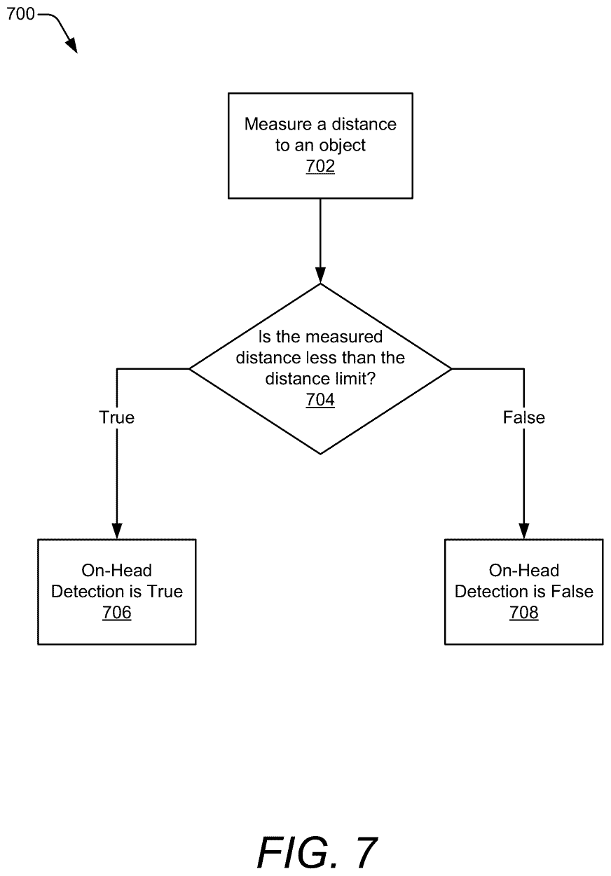

The on-head detector 326 accepts information from the optical sensor 112, such as the measured distance to an object. The on-head detector 326 determines whether on-head detection 114 is true or false by comparing the measured distance to a distance limit 328. The distance limit 328 can be predetermined based on a design of the hearable 102. In some cases, the distance limit 328 can be dynamically adjusted based on a size of an car tip 308 that is attached to the housing 306. In general, the distance limit 328 is a value that is less than a distance between the optical sensor 112 and a flat surface while the hearable 102 is at rest on the flat surface, as further described with respect to FIG. 6. Example distance limits 328 can include values that are approximately eight millimeters or less (e.g., five, three, or two millimeters). In general, the term “approximately” can refer to the distance limit 328 being within 10% of the specified distance or less (e.g., within 5%, 2%, 1% or less of the specified value). An operation of the on-head detector 326 is further described with respect to FIG. 7.

Although not explicitly shown, some implementations of the hearable 102 can include at least one power source, such as a battery or battery pack. In some implementations, the battery is rechargeable. Components of the hearable 102 are further described with respect to FIG. 4.

### On-Head Detection using a Single Optical Sensor

FIG. 4 illustrates an example lens structure 320 of the hearable 102. At 400-1, the hearable 102 is shown with the housing 306. The housing 306 includes a tip portion 402 (or snout), which is a portion of the housing 306 that can be in close proximity to the user's ear canal 110. The tip portion 402 can extend from another portion of the housing 306. An car tip 308 is attached to the tip portion 402. The tip portion 402 is further described at 400-2.

At 400-2, the tip portion 402 is shown to include a portion of the housing 306, which is represented by a pattern of diamonds in FIG. 4. The housing 306 forms a cavity 404, which houses other components of the hearable 102. For example, the lens structure 320 and the optical sensor 112 are positioned within a section of the cavity 404 that is associated with the tip portion 402. In some implementations, portions of the lens structure 320 can extend beyond the tip portion 402. The lens structure 320 is represented by a pattern having a first concentration of dots. The optical sensor 112 is represented by a pattern with a single set of diagonal lines.

Other material and components can be positioned within the cavity 404 to support the positioning of the lens structure 320 and the optical sensor 112. Some examples include bonding material 406 and pads 408-1 and 408-2. The bonding material 406 can represent a type of adhesive, such as a pressure-sensitive adhesive (PSA). In FIG. 4, the bonding material 406 is depicted by a pattern having a second concentration of dots with a higher density than the pattern associated with the lens structure 320. The pads 408-1 and 408-2 can represent flex pads or mounting pads.

As shown in FIG. 4, the housing 306 has at least one opening 410 (or hole) within the tip portion 402. The lens structure 320 at least partially fills this opening 410. In this example, the lens structure 320 partially fills the opening 410 such that gaps 412 are present between the lens structure 320 and the housing 306. In this manner, the hearable 102 is not completely sealed as the lens structure 320 is not in direct contact with the housing 306. The gaps 412 can help equalize pressure within the user 106′s ear 108 and allow ambient sound to be detected by the feedback microphone 314 for active noise cancellation.

The bonding material 406 can be disposed between the housing 306 and the lens structure 320 to enable the lens structure 320 to be attached to, but physically separate from, the housing 306 to form the gaps 412. In this manner, the bonding material 406 can protect the components inside the housing 306 from contaminants and foreign objects. With the bonding material 406, the lens structure 320 is seated into the housing 306.

A portion of the lens structure 320 that is positioned within the opening 410 of the housing 306 forms an optical window 414. The optical window 414 is substantially transparent to the light emitted and detected by the optical sensor 112. In some implementations, the housing 306 may not be transparent to (e.g., may significantly attenuate) the light emitted and detected by the optical sensor 112. The optical window 414 can protect the optical sensor 112 from contaminants and foreign objects.

The optical sensor 112 is oriented towards the opening 410 within the housing 306 such that it emits and detects light that passes through the optical window 414 of the lens structure 320. An orientation of the optical sensor 112 relative to the optical window 414 is further described with respect to FIG. 5.

FIG. 5 illustrates a geometry of the lens structure 320 of the hearable 102 to mitigate crosstalk for on-head detection 114. In the depicted configuration, the optical window 414 is aligned along a lens axis 502 such that the portion of the lens structure 320 that partially fills the opening 410 of the housing 306 extends along the lens axis 502. In other words, a height 512 of a cylindrical portion of the optical window 414 is substantially parallel to the lens axis 502. The optical window 414 has a first surface 504 that faces an external environment. This surface 504 can function as a portion of the exterior of the hearable 102.

The lens structure 320 has a second surface 506 that is opposite the first surface 504. The second surface 506 functions as a mounting point for the optical sensor 112. A dimension of the surface 506 extends along a sensor cavity axis 508. An angle 510 between the sensor cavity axis 508 and the lens axis 502 is offset from ninety degrees by approximately one degree or more (e.g., ±1, ±2, ±3, ±5 or more degrees). In an example implementation, the angle 510 between the lens axis 502 and the sensor cavity axis 508 is approximately 87 or 93 degrees. The term “approximately” can refer to an angle being within ±0.5 degrees of a specified value. The optical sensor 112 is attached or physically coupled to the surface 506. In this manner, a surface of the optical sensor 112 that faces the surfaces 504 and 506 is angled or tilted relative to the lens axis 502 by the same angle 510. This orientation means a height 514 of a surface of the optical sensor 112 that faces the surface 506 is substantially parallel to the sensor cavity axis 508.

This offset reduces the crosstalk generated by the optical sensor 112 by effectively pointing an emitter (or transmitter) of the optical sensor 112 away from a detector (or receiver) of the optical sensor 112. In particular, the angle 510 reduces an amount of internal reflections within the lens structure 320 that can be detected by the optical sensor 112. Example orientations of the hearable 102 are further described with respect to FIG. 6.

FIG. 6 illustrates example orientations 600-1 and 600-2 of the hearable 102 at static equilibrium (e.g., a state of rest) on a surface 602 that is substantially flat. The term “substantially flat” can refer to the surface 602 being sufficiently horizontal such that the hearable 102 does not roll off the surface 602 and can achieve static equilibrium when placed on the surface 602. In this example, the shape of the housing 306 causes the hearable 102 to achieve static equilibrium at either of the orientations 600-1 or 600-2 when placed on the surface 602. A center of gravity of the hearable 102 can cause the hearable 102 to reach static equilibrium at either of the orientations 600-1 or 600-2, even if the user 106 places the hearable 102 on the surface 602 with a different initial orientation. The hearable 102 can also realize these different orientations 600-1 or 600-2 with different sized car tips 308.

Both orientations 600-1 and 600-2 cause the surface 602 to be within a field-of-view 604 of the optical sensor 112. This means that the optical sensor 112 can detect the surface 602. In particular, the optical sensor 112 can emit light that reflects off the surface 602 and detect the reflected light to determine a distance between the optical sensor 112 and the surface 602. The position and orientation of the optical sensor 112 within the hearable 102 can ensure that the car tip 308 is outside of the field-of-view 604.

The orientations 600-1 and 600-2 also cause distances 606-1 and 606-2 between the optical sensor 112 and the surface 602 to be greater than the distance limit 328 associated with on-head detection 114. Consider an example in which the distance limit 328 is approximately eight millimeters or less. At the orientation 600-1, the distance 606-1 between the optical sensor 112 and the surface 602 is approximately nine millimeters. At the orientation 600-2, the distance 606-2 between the optical sensor 112 and the surface 602 is approximately fifteen millimeters. In general, the term “approximately” refers to the distance being within 10% of the specified distance or less (e.g., within 5%, 2%, 1% or less of the specified value). Due to the distances 606-1 and 606-2 being greater than the distance limit 328, the hearable 102 can mitigate false detections caused by placement of the hearable 102 on the surface 602, as further described with respect to FIG. 7.

In addition to the above descriptions, the hearable 102 can be configured to account for varying physical properties (e.g., an elasticity, an inner and outer circumference, or a radius) of different sized and/or different material car tips 308. In one example, the hearable 102 can adjust the distance limit 328 based on the elasticity of different sized car tips 308, such as by using a table of distance limits 328 for a given sized car tip 308. In this way, a large-sized car tip that compresses more than a small-sized car tip, resulting in a smaller distance (e.g., distance 606) when the hearable 102 is in a given orientation 600, can be accounted for by the hearable 102. The hearable 102 can be further configured to determine different sized and/or different material car tips 308 by, for example, prompting a user 106 to provide information relating car tips 308 via the smart device 104 or using the optical sensor 112 or performing a calibration procedure.

The example hearable 102 in FIG. 6 can achieve static equilibrium on the surface 602 at two orientations 600-1 and 600-2. In general, the hearable 102 can be designed to achieve static equilibrium on the surface 602 at any quantity of orientations 600. For example, some hearables 102 can achieve static equilibrium at a single orientation. Other hearables 102 can achieve at more than two orientations, such as three, four, or more orientations 600. These orientations ensure that the distance 606 between the optical sensor 112 and the surface 602 is greater than the distance limit 328.

FIG. 7 illustrates an example flow diagram 700 for performing on-head detection using a single optical sensor 112. At 702, the optical sensor 112 measures and distance to an object. The object can be a portion of the user 106′s ear 108 or a portion of the surface 602. The optical sensor 112 can measure the distance using a waveform with a particular wavelength. The measured distance is passed to the on-head detector 326.

At 704, the on-head detector 326 compares the measured distance to the distance limit 328. If the measured distance is less than the distance limit 328, the on-head detector 326 determines that on-head detection 114 is true, as shown at 706. If the measured distance is greater than the distance limit 328, the on-head detector 326 determines that on-head detection 114 is false, as shown at 708. With these techniques, false positives associated with on-head detection 114 can be mitigated without adding additional sensors (e.g., another infrared sensor, another proximity sensor, or a motion sensor) and without utilizing more complex optical sensors that determine additional information about the object, such as material composition. In some cases, the distance limit 328 is dynamically adjusted based on current information about the hearable 102. For example, the distance limit 328 can be adjusted based on the size of an car tip 308 that is currently attached to the hearable 102.

### Example Method

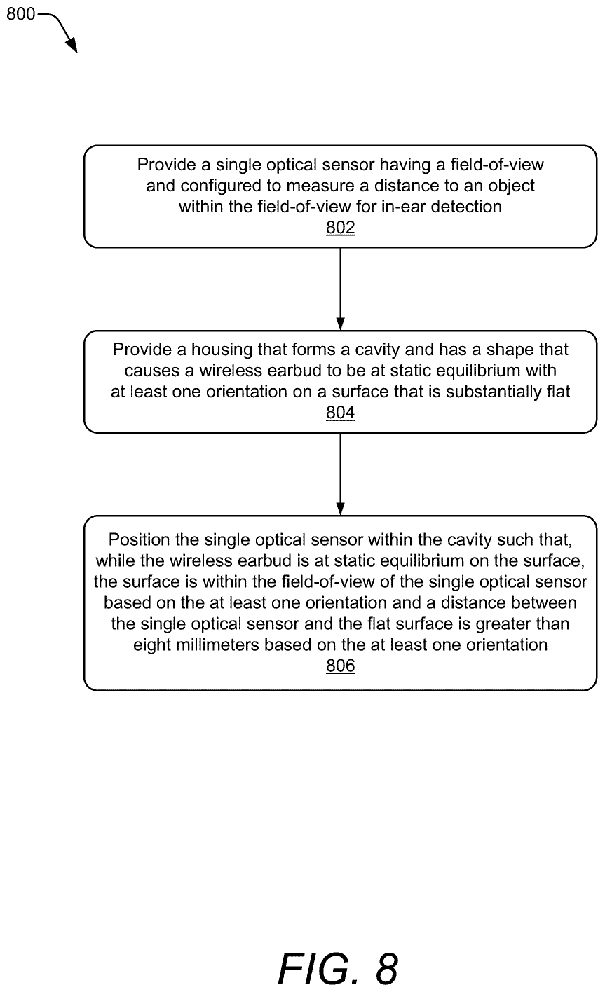

FIG. 8 depicts an example method 800 for manufacturing a hearable with on-head detection using a single optical sensor. Method 800 is shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIGS. 2 and 3, reference to which is made for example only. The techniques are not limited to performance by one entity or multiple entities operating on one device.

At 802, a single optical sensor having a field-of-view and configured to measure a distance to an object within the field-of-view for in-car detection is provided. For example, the manufacturing process provides the optical sensor 112, which can be an infrared sensor in some implementations.

At 804, a housing that forms a cavity and has a shape that causes a wireless carbud to be at static equilibrium with at least one orientation on a surface that is substantially flat is provided. For example, the manufacturing process provides the housing 306, which forms the cavity 404 as shown in FIG. 4. The housing 306 has a shape that causes the wireless earbud 302-1 (or more generally the hearable 102) to be at static equilibrium with at least one orientation 600 on a surface 602 that is substantially flat, as shown in FIG. 6.

At 806, the single optical sensor is positioned within the cavity such that, while the wireless carbud is at static equilibrium on the surface, the surface is within the field-of-view of the single optical sensor based on the at least one orientation and a distance between the single optical sensor and the surface is greater than eight millimeters based on the at least one orientation. For example, the manufacturing process positions the optical sensor 112 within the cavity 505 such that, while the wireless carbud 302-1 is at static equilibrium on the surface 602, the surface 602 is within the field-of-view 604 of the optical sensor 112 and based on the at least one orientation 600 and the distance 606 between the optical sensor 112 and the surface 602 is greater than eight millimeters. Although described with respect to a wireless earbud 302-1, similar steps can be applied to other types of hearables 102, including a wired carbud 302-2 or a headphone 302-3.

### Example Computing System

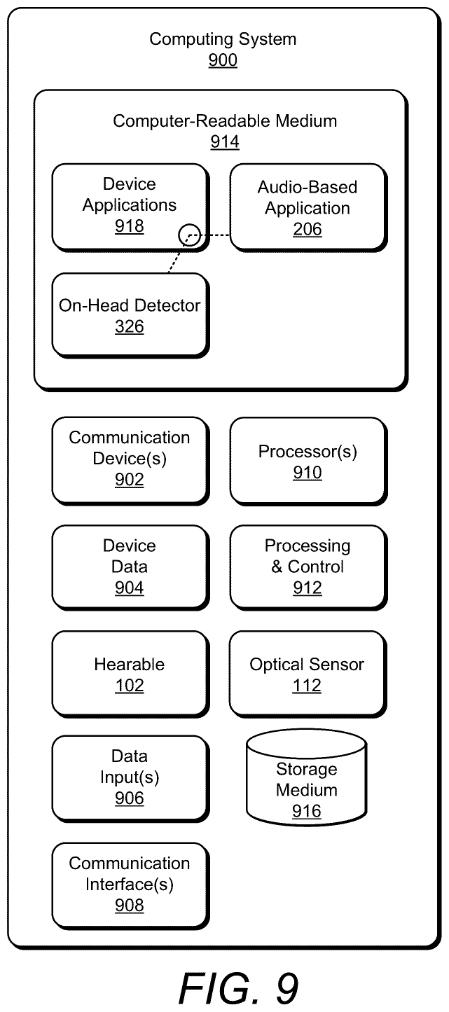

FIG. 9 illustrates various components of an example computing system 900 that can be implemented as any type of client, server, and/or computing device as described with reference to the previous FIGS. 2 and 3 to implement aspects of a hearable with on-head detection using a single optical sensor.

The computing system 900 includes communication devices 902 that enable wired and/or wireless communication of device data 904 (e.g., acoustic content). The communication devices 902 or the computing system 900 can include one or more hearables 102. The device data 904 or other device content can include configuration settings of the device, media content stored on the device, and/or information associated with a user of the device. Media content stored on the computing system 900 can include any type of audio, video, and/or image data. The computing system 180 includes one or more data inputs 906 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 900 also includes communication interfaces 908, which can be implemented as any one or more of a serial and/or parallel interface, a wireless interface, any type of network interface, a modem, and as any other type of communication interface. The communication interfaces 908 provide a connection and/or communication links between the computing system 900 and a communication network by which other electronic, computing, and communication devices communicate data with the computing system 900.

The computing system 900 includes one or more processors 910 (e.g., any of microprocessors, controllers, and the like), which process various computer-executable instructions to control the operation of the computing system 900. Alternatively or in addition, the computing system 900 can be implemented with any one or combination of hardware, firmware, or fixed logic circuitry that is implemented in connection with processing and control circuits which are generally identified at 912. The computing system 900 includes at least one optical sensor 112, which can be implemented as part of the hearable 102 or the communication device 902. Although not shown, the computing system 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 900 also includes a computer-readable medium 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 900 can also include a mass storage medium device (storage medium) 916.

The computer-readable medium 914 provides data storage mechanisms to store the device data 904, as well as various device applications 918 and any other types of information and/or data related to operational aspects of the computing system 900. For example, an operating system 920 can be maintained as a computer application with the computer-readable medium 914 and executed on the processors 910. The device applications 918 may include a device manager, such as any form of a control application, software application, signal-processing and control module, code that is native to a particular device, a hardware abstraction layer for a particular device, and so on.

The device applications 918 also include any system components, engines, or managers to implement on-head detection 114. In this example, the device applications 918 include the audio-based application 206 of FIG. 2 and the on-head detector 326 of FIG. 3.

Although described with respect to hearables 102, the techniques for performing on-head detection 114 using a single optical sensor 112 can be adapted for other types of devices and/or use cases. For example, these techniques can be applied to on-head detection 114 for hearing aids. As another example, these techniques can be applied to on-human tissue detection for a thermometer or a computing watch.

### Conclusion

Although techniques using, and apparatuses including, a hearable with on-head detection using a single optical sensor have been described in language specific to features and/or methods, it is to be understood that the subject of the appended claims is not necessarily limited to the specific features or methods described. Rather, the specific features and methods are disclosed as example implementations of a hearable with on-head detection using a single optical sensor.

What is claimed is:

1. A wireless earbud configured to perform in-ear detection, the wireless earbud comprising:
a single optical sensor configured to:
have a field-of-view; and
measure a distance to an object within the field-of-view for the in-ear detection; and
a housing configured to:
have a shape that causes the wireless earbud to be at static equilibrium with at least one orientation on a surface that is substantially flat; and
form a cavity,
wherein the single optical sensor is positioned within the cavity such that, while the wireless earbud is at the static equilibrium on the surface, the surface is within the field-of-view of the single optical sensor based on the at least one orientation and a distance between the single optical sensor and the surface is greater than approximately eight millimeters based on the at least one orientation.

2. The wireless earbud of claim 1, wherein:
the single optical sensor comprises a single infrared sensor; and
the single infrared sensor is configured to independently emit infrared light, detect a portion of the infrared light that is reflected by the object within the field-of-view, and measure the distance to the object.

3. The wireless earbud of claim 1, wherein a distance limit associated with the in-ear detection has another value that is less than the distance between the single optical sensor and the surface.

4. The wireless earbud of claim 3, wherein the wireless earbud is configured to determine that the in-ear detection is true based on the measured distance being less than the distance limit.

5. The wireless earbud of claim 3, wherein the wireless earbud is configured to determine that the in-ear detection is false based on the measured distance being greater than the distance limit.

6. The wireless earbud of claim 5, wherein the wireless earbud is configured to:
determine that the in-ear detection is false without utilizing information from another sensor; or
determine that the in-ear detection is false using the single optical sensor to determine a material composition of the object.

7. The wireless earbud of claim 1, wherein the at least one orientation comprises a first orientation in which the distance between the single optical sensor and the surface is approximately nine millimeters.

8. The wireless earbud of claim 7, wherein the at least one orientation comprises a second orientation in which the distance between the single optical sensor and the surface is approximately fifteen millimeters.

9. The wireless earbud of claim 1, wherein the wireless earbud is configured to have a center of gravity that causes the wireless earbud to reach static equilibrium on the surface for the at least one orientation.

10. The wireless earbud of claim 1, wherein:
the housing is configured to be selectively coupled to ear tips of different sizes; and
the housing is configured to have the at least one orientation on the surface while coupled to each of the ear tips.

11. The wireless earbud of claim 1, further comprising:
a lens structure positioned within the cavity, the lens structure comprising material that is substantially transparent to light emitted by the optical sensor, wherein:
the housing comprises an opening;
the lens structure is configured to partially fill the opening within the housing; and
the single optical sensor is physically coupled to the lens structure and oriented such that the field-of-view of the single optical sensor extends out through portions of the lens structure and the opening within the housing.

12. The wireless earbud of claim 11, wherein:
the lens structure comprises an optical window with a cylindrical portion having a height that is parallel to a first axis; and
a surface of the single optical sensor that faces the optical window has a height that is parallel to a second axis that intersects the first axis and forms an angle that is offset from ninety degrees by approximately three degrees.

13. The wireless earbud of claim 11, further comprising:
a feedback microphone physically coupled to the lens structure and configured to provide a feedback signal for active noise cancellation.

14. A method of manufacturing a wireless earbud, the method comprising:
providing a single optical sensor having a field-of-view and configured to measure a distance to an object within the field-of-view for in-ear detection;
providing a housing that forms a cavity and has a shape that causes the wireless earbud to be at static equilibrium with at least one orientation on a surface that is substantially flat; and
positioning the single optical sensor within the cavity such that, while the wireless earbud is at static equilibrium on the surface, the surface is within the field-of-view of the single optical sensor based on the at least one orientation and a distance between the single optical sensor and the surface is greater than eight millimeters based on the at least one orientation.

15. The method of claim 14, wherein the providing the single optical sensor comprises providing a single infrared sensor.

16. The method of claim 14, wherein:
the at least one orientation comprises:
a first orientation in which the distance between the single optical sensor and the surface is approximately nine millimeters; and
a second orientation in which the distance between the single optical sensor and the surface is approximately fifteen millimeters; and
the method further comprises causing the wireless earbud to have a center of gravity such that the wireless earbud reaches static equilibrium on the surface at the first orientation and the second orientation.

17. The method of claim 14, further comprising:
providing ear tips of different sizes that can be selectively coupled to the housing,
wherein the providing the housing comprises forming the housing to have the shape that causes the wireless earbud to be at static equilibrium with the at least one orientation while coupled to each of the ear tips.

18. The method of claim 14, further comprising:
providing a lens structure comprising material that is substantially transparent to light; and
positioning the lens structure within the cavity, the lens structure partially filling an opening within the housing,
wherein the positioning of the single optical sensor comprises physically coupling the single optical sensor to the lens structure and orienting the single optical sensor such that the field-of-view extends out through the opening within the housing.

19. The method of claim 18, wherein:
the providing of the lens structure comprises providing an optical window with a cylindrical portion having a height that is parallel to a first axis; and
the orienting of the single optical sensor comprises causing a surface of the single optical sensor that faces the optical window to have a height that is parallel to a second axis that intersects the first axis and forms an angle that is offset from ninety degrees by approximately three degrees.

20. The method of claim 18, further comprising:
physically coupling a feedback microphone to the lens structure.
